(19) United States
(12) Patent Application Publication
(10) Pub. No.: US 2025/0340347 A1
(43) Pub. Date: Nov. 6, 2025

(54) PACKAGING MATERIAL

(71) Applicant: Graphic Packaging International, LLC, Atlanta, GA (US)

(72) Inventors: Jeffrey T. Sloat, Broomfield, CO (US); William Gilpatrick, Broomfield, CO (US)

(21) Appl. No.: 19/196,830

(22) Filed: May 2, 2025

Related U.S. Application Data
(60) Provisional application No. 63/641,487, filed on May 2, 2024.

(51) Int. Cl. B65D 65/40; B32B 27/10; B32B 27/20; B32B 27/36; B32B 37/18; B65D 65/42

(52) U.S. Cl. CPC B65D 65/40; B32B 27/10; B32B 27/20; B32B 27/36; B32B 37/182; B65D 65/42; B32B 2317/12; B32B 2367/00; B32B 2553/00

(57) ABSTRACT

A packaging material comprising a base layer and a film layer extending along the base layer. The film layer comprises at least a biopolymer and one or more naturally sourced additives.

### CROSS-REFERENCE TO RELATED APPLICATIONS

This application claims the benefit of U.S. Provisional Patent Application No. 63/641,487, filed on May 2, 2024.

### INCORPORATION BY REFERENCE

The disclosure of U.S. Provisional Patent Application No. 63/641,487, which was filed on May 2, 2024, is hereby incorporated by reference for all purposes as if presented herein in its entirety.

### BACKGROUND OF THE DISCLOSURE

The present disclosure generally relates to materials (e.g., composite materials) for forming packaging constructs.

### BRIEF SUMMARY OF SOME ASPECTS OF THE DISCLOSURE

In one aspect, the disclosure is generally directed to a packaging material comprising a first layer and a second layer extending along the first layer. The second layer comprises at least a biopolymer and one or more naturally sourced additives.

In another aspect, the disclosure is generally directed to a method of forming a packaging material. The method can comprise obtaining a first layer and forming a second layer along the first layer by applying a film material to the first layer. The film material can comprise a biopolymer and one or more naturally sourced additives.

Other aspects, features, and details of the present disclosure can be more completely understood by reference to the following detailed description of exemplary embodiment taken in conjunction with the drawings and from the appended claims.

### BRIEF DESCRIPTION OF THE DRAWINGS

Those skilled in the art will appreciate the above stated advantages and other advantages and benefits of various additional embodiments reading the following detailed description of the exemplary embodiments with reference to the below-listed drawing figures. Further, the various features of the drawings discussed below are not necessarily drawn to scale. Dimensions of various features and elements in the drawings may be expanded or reduced to more clearly illustrate the exemplary embodiments of the disclosure.

FIG. 1A is a schematic perspective view of a portion of an exemplary packaging material according to embodiments of the present disclosure.

FIG. 1B is a schematic perspective view of a portion of an exemplary packaging material according to alternative embodiments of the present disclosure.

FIG. 2 is a schematic perspective view of a system that forms a packaging material by coating a first layer with a second layer according to embodiments of the present disclosure.

FIG. 3 is a schematic perspective view of a system that forms a packaging material by laminating a first layer with a second layer according to embodiments of the present disclosure.

Corresponding parts are designated by corresponding reference numbers throughout the drawings.

### DETAILED DESCRIPTION OF EXEMPLARY EMBODIMENTS

The present disclosure generally relates to a packaging material comprising a film layer (e.g., a laminated layer or coating) extending on a substrate and/or other suitable layer(s). The packaging material can be for forming a construct (e.g., a container, carton, carrier, wrap, package, sleeve, bowl, tray, cup, insulated cup, and/or other constructs). In some embodiments, a packaging material can include other materials (e.g., injection-molded polymer elements) in addition to the lamination or coating. The construct, for example, can be used for holding, storing, freezing, heating, cooking, etc. food products or other products. In examples, a construct can be configured for holding a food product while heating in a microwave oven, a conventional oven, or both (e.g., dual oven heating), for hermetic sealing (e.g., extended life modified atmosphere packaging, vacuum scaled packaging, etc.), for refrigeration/freezing storage, and/or for serving foods and/or beverages and/or other suitable products. Additionally, the packaging material and/or a construct made from the packaging material can include microwave packaging elements (e.g., microwave energy interactive elements, such as a microwave susceptor element, a microwave shield element, etc.) and/or seals configured to automatically vent during heating or transportation at high altitude. Other uses and styles of composite constructs are also included in the present disclosure.

In the present embodiments, the materials of the elements of the packaging material can include sustainable and/or renewable materials, natural fibers, repulpable materials, and/or degradable materials. For example, renewable materials could be at least partially derived from biological processes or other processes wherein the supply can be replenished in a reasonable time period, which can include annually renewable plant sources, plant sources that can be renewed in years or decades, algae, bacteria, or any other suitable source. In one example, a reasonable time period for replenishing or at least partially replenishing a resource can be within an average person's lifetime. A polymer that is derived solely from fossil-based petrochemicals might not be considered a bio-derived polymer, for example; however, some substances that are similar to petrochemicals (e.g., petrochemical analogues) can be produced at least partially by microbes, plants, and/or other biological sources or by chemically reacting or modifying bio-sourced materials, for example, and these at least partially bio-derived petrochemical analogues can be used to produce at least partially bio-derived polymers. A natural fiber can be any at least partially naturally occurring fiber, such as those derived from plants (e.g., wood fibers, cotton, hemp, jute, flax, coir, bamboo, sugarcane, rice husks, banana fiber, ramie, sisal, and other plants). In embodiments, sustainable/renewable/naturally sourced materials can be non-petroleum-based materials. A repulpable material (e.g., paper products) can be a material that can be returned to a pulp (e.g., by chemical, mechanical, and/or other suitable methods) for making a new material from the pulp (e.g., recycled paper). A degradable material could be an at least partially compostable material, biodegradable material, and/or other materials that can at least partially break down into small parts that are relatively harmless to the environment and/or into nutrients (e.g., for beneficial plants and/or bacteria) in a reasonable amount of time.

According to exemplary embodiments, renewable and/or degradable materials can include at least partially bio-based resins/polymers (“bioresins” or “biopolymers”), polymers that are non-petroleum-based, polymers that are at least partially formed from chemicals that are output by or extracted from biological organisms (e.g., plants, algae, bacteria, animals), paper products, natural fibers, and/or other materials. Paperboard and other paper products are often recognized as inherently sustainable/renewable materials as the trees and other plants that provide raw materials for the paper products can be and are routinely replanted in a sustainably renewable fashion. In embodiments, the renewable and/or degradable material can be processed in injection molding applications, can be bonded or otherwise applied to a substrate (e.g., via extrusion coating, laminating, etc.), has sealing, barrier, and/or venting properties, and/or has temperature resistance for heating (e.g., microwave and/or conventional oven) and/or for refrigeration/freezing or other storage. Other renewable and/or degradable materials also can be used without departing from the present disclosure.

The materials of the packaging material can have suitable properties for the particular type of construct made from the packaging material. For example, a construct that is a tray or other container for holding and/or serving a food product, beverage, etc. can comprise a barrier layer that is permeable or impermeable to certain gases, liquids, and/or other flowable materials (e.g., oils, oxygen, water, etc.). A construct for heating a food product can comprise renewable materials with a temperature resistance of at least about 165 degrees Fahrenheit (at least about 74 degrees Celsius) since it is often recommended to heat many food products to at least this temperature. In another embodiment, the construct can comprise renewable materials with a temperature resistance of at least about 212 degrees Fahrenheit (at least about 100 degrees Celsius) for boiling water for example. Applications with lower temperature resistance requirements can include, for example, non-food heating, heating beverages, reheating some food items, applications that only require storage and/or cooling, and/or other suitable applications. Some applications can have higher temperature resistance requirements, such as for food products that require a higher external temperature in order to reach a minimum internal temperature, and/or for heating food products at least partially in a conventional oven, which can be set at higher temperatures for heating a food product via conduction and/or convection. Other considerations for selecting a suitable material can include material strength for supporting the weight of a product and/or for stacking, for tear resistance and/or bending resistance, for tensile strength, etc.

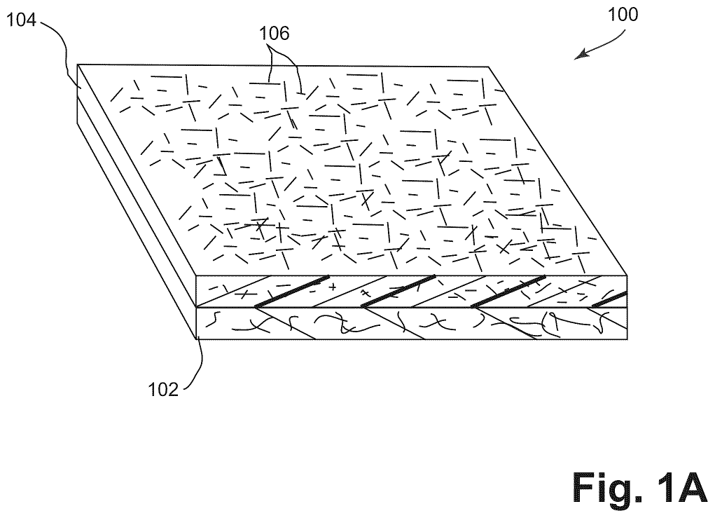

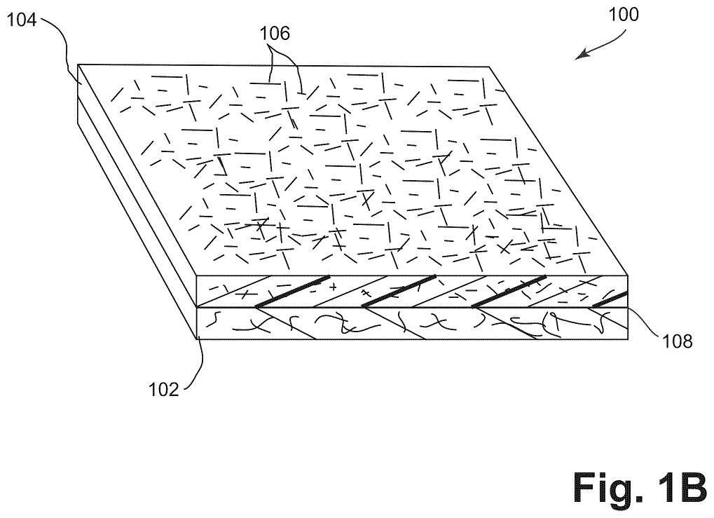

In the illustrated embodiments, the packaging material 100 can include a first layer or base layer 102 (e.g., a substrate or a support layer 102) and a second layer or film layer 104 (e.g., a lamination, coating, liner, barrier layer, etc.). In exemplary embodiments, the film layer 104 can be applied to the base layer 102 by extrusion coating, printing (e.g., flexo/gravure) and/or flat roller applicators, flood coating, laminating, and/or other suitable processes. In embodiments, the film layer 104 can be secured directly to a face of the base layer 102 and/or could be adhered, heat sealed, and/or otherwise attached to the base layer 102. The base layer 102 can be a paper product (e.g., paper, paperboard, cardboard, and/or other suitable fibrous and/or non-fibrous materials), other suitable materials that are renewable, degradable, compostable, and/or repulpable, and/or any other suitable materials. In embodiments, the film layer 104 can include a biopolymer (e.g., bioplastic) in combination with sustainable and/or naturally sourced additive(s) 106 (schematically shown in FIG. 1). For example, the biopolymer can comprise polylactic acid (PLA), polyhydroxyalkanoates (PHAs), polybutylene adipate co-terephthalate (PBAT), and/or other suitable biopolymers. In embodiments, the additives can include cellulose fibers and/or other suitable natural fibers, calcium carbonate, kaolin clay, impact modifiers, and/or other suitable sustainable and/or naturally sourced materials. In exemplary embodiments, the natural fibers can be dispersed in the biopolymer, such as by mixing and/or other suitable processes.

In the illustrated embodiments, the packaging material 100 can provide a sustainable functional biopolymer composite material from renewable resources (e.g., the base layer 102 being paper-based and the film layer 104 including a biopolymer and sustainable and/or naturally sourced additives) with improved physical/mechanical properties (e.g., increased tear resistance, tensile strength, and/or other physical attributes), for example. In embodiments, the film layer 104 can be formed by incorporating the additives 106 into the biopolymer before and/or after the biopolymer is applied to the base layer 102. The film layer 104 can be applied to the base layer 102 by extrusion coating, by flood coating, by applicators (e.g., spray nozzles, rollers, etc.), by applying the material of the film layer 104 in a solution and curing, and/or by other suitable processes. In embodiments, the film layer 104 and the base layer 102 can be laminated together, such as by applying pressure and/or heat and/or using adhesive, heat sealers, etc. to at least partially secure the film layer 104 to the base layer 102. For example, as schematically shown in FIG. 1B, the film layer 104 can be attached to the base layer 102 by one or more bonding materials 108, such as an adhesive, a heat-scaling material, etc.

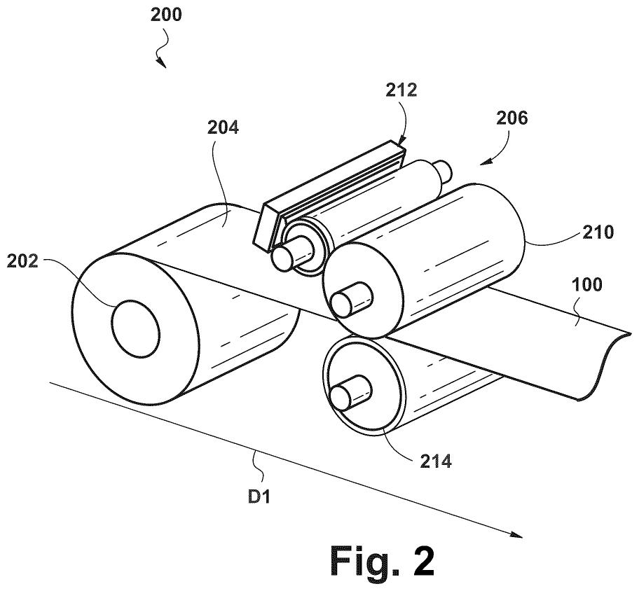

In an exemplary embodiment, the film layer 104 can be coated on to the base layer 102. As schematically shown in FIG. 2, a system 200 can include a supply roller 202 that feeds a web 204 of the base layer material in a machine direction or downstream direction D1 (e.g., with guide rollers and/or other suitable features). In the illustrated embodiments, the web 204 can pass through a coating station 206, which can apply a film material (e.g., the biopolymer with the sustainable and/or naturally sourced additives) to the web 204. For example, the film material can be in the form of a liquid or semi-liquid or could be in another suitable flowable state, and the flowable film material can be applied to a transfer roller 210 by an applicator apparatus 212. The transfer roller 210 can carry the film material from the applicator apparatus 212 to the web 204 while turning on its axis (e.g., turning in the counterclockwise direction in the view of FIG. 2). The film material can be transferred to the web 204 from the transfer roller 210 as the web passes between the transfer roller 210 and an opposing roller 214 positioned below the web 204. The system 200 can carry the web 204 with the applied film material in the machine direction D1 away from the coating station 206, and the film material can be cured/dried/solidified on the web 204 so that the web 204 forms the base layer 102 and the film material forms the film layer 104 of the packaging material 100. In embodiments, the system 200 can include features (not shown) for assisting in curing and/or drying and/or solidifying the film material.

The system 200 and any of its components could be otherwise shaped, arranged, positioned, and/or configured without departing from the disclosure. For example, the coating station 206 could include different roller applicators, spray nozzles, flood coating apparatus, etc. in place of or in addition to the transfer roller 210.

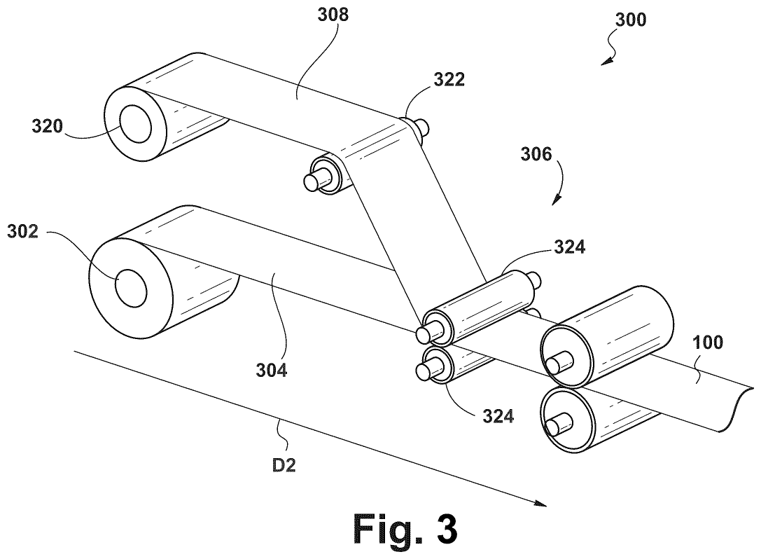

In another exemplary embodiment, the film layer 104 can be laminated on the base layer 102. As schematically shown in FIG. 3, a system 300 can include a first supply roller 302 that feeds a web 304 of the base layer material in a machine direction or downstream direction D2 (e.g., with guide rollers and/or other suitable features). In the illustrated embodiments, the web 304 can pass through a laminating station 306, which can apply a web 308 of the film material (e.g., the biopolymer with the sustainable and/or naturally sourced additives) to the web 304. In embodiments, the web 308 of the film material can be fed from a second supply roller 320 along one or more guide rollers 322. As the webs 304, 308 are moved in the machine direction D2, the webs 304, 308 can be brought together between a pair of opposed nip rollers 324, which can guide the webs 304, 308 into overlapping relationship and can nip the webs 304, 308 together. In embodiments, the overlapped webs 304, 308 can be pressed together (e.g., by the nip rollers 324 and/or other rollers and/or other suitable features) to cause the film material to fuse and/or bond to the base layer 102. In some embodiments, an adhesive and/or heat sealer can be applied to the upper surface of the web 304 of base layer material and/or to a lower surface of the web 308 of film material so that the bonding material 108 extends between the base layer 102 and the film layer 104 of the packaging material 100. In exemplary embodiments, heat and/or pressure can be used to attach the webs 304, 308 together whether or not a bonding material is used. The system 300 and any of its components could be otherwise shaped, arranged, positioned, and/or configured without departing from the disclosure.

The packaging material 100 having the base layer 102 (e.g., a paper-based base layer, such as paperboard) and the film layer 104 including a biopolymer with sustainable and/or naturally sourced additives can have many advantages over other materials. For example, the packaging material 100 of the present disclosure can provide a composite material with improved physical/mechanical properties (e.g., strength) over other materials and/or composite materials without the additives 106 while providing a material that can be recycled easily and/or can be degradable (e.g., compostable).

According to embodiments, the packaging material includes multiple layers, each comprising materials that are derived from up to 100 percent renewable sources and/or are degradable and/or recyclable materials. Accordingly, the composite constructs can have little or no strain on non-renewable resources, can help reduce or eliminate waste, and the use of renewable and/or degradable materials can be advertised to a consumer.

In accordance with the exemplary embodiments, the packaging material can be formed into blanks for forming respective constructs (e.g., trays, cartons, fast food containers, bowls, cups, insulated cups, carriers, wraps, lids, etc.), such as by press-forming, folding, gluing, and/or other suitable processes. The base layer can be formed from paperboard, corrugated cardboard and/or other materials having properties suitable for at least generally enabling respective functionalities described above. Paperboard can be of a caliper such that it is heavier and more rigid than ordinary paper, and corrugated cardboard can be of a caliper such that it is heavier and more rigid than paperboard. Generally, at least the side of the paperboard or cardboard that will be an exterior surface in the carton erected therefrom will be coated with a clay coating, or the like. The clay coating can be printed over with product, advertising, price-coding, and other information or images. The blanks may then be coated with a varnish to protect any information printed on the blanks. The blanks may also be coated with, for example, a moisture barrier layer, on one or both sides. The blanks can also be laminated to or coated with one or more sheet-like materials.

The foregoing description illustrates and describes various embodiments of the disclosure. As various changes could be made in the above construction, it is intended that all matter contained in the above description or shown in the accompanying drawings shall be interpreted as illustrative and not in a limiting sense. Furthermore, various modifications, combinations, and alterations, etc., of the above-described embodiments are within the scope of the disclosure. Additionally, the disclosure shows and describes only selected embodiments, but various other combinations, modifications, and environments are within the scope of the disclosure, commensurate with the above teachings, and/or within the skill or knowledge of the relevant art. Furthermore, certain features and characteristics of each embodiment may be selectively interchanged and applied to other illustrated and non-illustrated embodiments without departing from the scope of the disclosure.

What is claimed is:

1. A packaging material, comprising:
a first layer; and
a second layer extending along the first layer;
wherein the second layer comprises at least a biopolymer and one or more naturally sourced additives.

2. The packaging material of claim 1, wherein the second layer is a coating applied on a face of the first layer.

3. The packaging material of claim 1, wherein the second layer is laminated on a face of the first layer.

4. The packaging material of claim 1, wherein the biopolymer comprises at least one of polylactic acid, polyhydroxyalkanoates, and polybutylene adipate co-terephthalate.

5. The packaging material of claim 4, wherein the one or more naturally sourced additives comprises at least one of cellulose fibers, calcium carbonate, kaolin clay, and impact modifiers.

6. The packaging material of claim 1, wherein the one or more naturally sourced additives comprises one or more natural fibers.

7. The packaging material of claim 1, wherein the one or more naturally sourced additives comprises at least one of cellulose fibers, calcium carbonate, kaolin clay, and impact modifiers.

8. The packaging material of claim 1, wherein the second layer is attached to the first layer by a bonding material, the bonding material comprising at least one of an adhesive and a heat-sealing material.

9. The packaging material of claim 1, wherein the one or more naturally sourced additives are dispersed in the biopolymer.

10. The packaging material of claim 1, wherein the first layer comprises a paper-based material.

11. A method of forming a packaging material, comprising:
obtaining a first layer;
forming a second layer along the first layer by applying a film material to the first layer, the film material comprising a biopolymer and one or more naturally sourced additives.

12. The method of claim 11, wherein the applying the film material to the first layer comprises coating the first layer with the film material.

13. The method of claim 11, wherein the applying the film material to the first layer comprises laminating the film material on a face of the first layer.

14. The method of claim 11, wherein the biopolymer comprises at least one of polylactic acid, polyhydroxyalkanoates, and polybutylene adipate co-terephthalate.

15. The method of claim 14, wherein the one or more naturally sourced additives comprises at least one of cellulose fibers, calcium carbonate, kaolin clay, and impact modifiers.

16. The method of claim 11, wherein the one or more naturally sourced additives comprises one or more natural fibers.

17. The method of claim 11, wherein the one or more naturally sourced additives comprises at least one of cellulose fibers, calcium carbonate, kaolin clay, and impact modifiers.

18. The method of claim 11, wherein the applying the film material to the first layer comprises attaching the film material to the first layer with a bonding material, the bonding material comprising at least one of an adhesive and a heat-sealing material.

19. The method of claim 11, wherein the one or more naturally sourced additives are dispersed in the biopolymer.

20. The method of claim 11, wherein the first layer comprises a paper-based material.
